(19) United States
(12) Patent Application Publication
(10) Pub. No.: US 2026/0210871 A1
(43) Pub. Date: Jul. 23, 2026

(54) MONITORING TOOL AND METHOD OF USE

(71) Applicant: GlobalFoundries U.S. Inc., Malta, NY (US)

(72) Inventors: Tobias Kraeusslein, Malta, NY (US); Richard P. Good, Saratoga Springs, NY (US)

(21) Appl. No.: 19/034,116

(22) Filed: Jan. 22, 2025

(51) Int. Cl. G01N 21/88; G06T 7/00; G06T 7/13; G06T 7/68

(52) U.S. Cl. CPC G01N 21/8851; G06T 7/001; G06T 7/13; G06T 7/68; G01N 2021/8877; G06T 2207/30148; G06T 2207/30164

(57) ABSTRACT

The present disclosure relates to a monitoring tool and, more particularly, to a monitoring tool and method of use. The method includes: obtaining, by a computing device, an image of a tool used in processing equipment; comparing, by the computing device, a first side of the tool to a second side of the tool; determining, by the computing device, whether there is an asymmetry between the first side of the tool and the second side of the tool; and providing, by the computing device, a notification that there is the asymmetry between the first side of the tool and the second side of the tool.

### BACKGROUND

The present disclosure relates to a monitoring tool and, more particularly, to a monitoring tool and method of use.

Integrated circuits are manufactured using a large number of processes using different processing tools in a semiconductor facility (e.g., semiconductor fab). The processing tools may be, for example, deposition chambers, plasma etching chambers, lithography tools, etc. These processing tools need to maintain their integrity and maximize their efficiency. For example, these processing tools need to be free of contamination, e.g., contamination on dispense nozzles of lithography tools, to minimize yield loss.

### SUMMARY

In an aspect of the disclosure, a method comprises: obtaining, by a computing device, an image of a tool used in processing equipment; comparing, by the computing device, a first side of the tool to a second side of the tool; determining, by the computing device, whether there is an asymmetry between the first side of the tool and the second side of the tool; and providing, by the computing device, a notification that there is the asymmetry between the first side of the tool and the second side of the tool.

In an aspect of the disclosure, a computer program product comprises one or more computer readable storage media having program instructions collectively stored on one or more computer readable storage media. The program instructions are executable to: obtain an image of a dispensing nozzle taken by camera; identify a tip of the dispensing nozzle and its center point by performing edge detection on the image; compare sides of the dispensing nozzle from the image to ascertain one of symmetry and asymmetry at the tip of the dispensing nozzle; determine that the asymmetry is above a control threshold limit; and provide a notification of the asymmetry of the tip of the dispensing nozzle, upon determining that the asymmetry is above the control threshold limit.

In an aspect of the disclosure, a system comprises: a processor, a computer readable memory, one or more computer readable storage media, and program instructions collectively stored on the one or more computer readable storage media. The program instructions are executable to: obtain an image of a dispensing nozzle; perform edge detection to center and isolate a nozzle tip of the dispensing nozzle and maximize symmetry of the image; quantify an asymmetry of the image by subtracting and averaging pixel deltas of the image and optimal reflection; compare the asymmetry versus a control limit to ascertain if the asymmetry of the image is a fault; and if the control limit is exceeded, provide a notification of contamination existing on the nozzle tip, a hold or tool inhibit.

### BRIEF DESCRIPTION OF THE DRAWINGS

The present disclosure is described in the detailed description which follows, in reference to the noted plurality of drawings by way of non-limiting examples of exemplary embodiments of the present disclosure.

FIG. 1 depicts a computing node according to an embodiment of the present disclosure.

FIG. 2 shows a block diagram of an exemplary processing tool in accordance with aspects of the disclosure.

FIG. 3 shows an enlarged view of a nozzle dispensing unit of a processing tool in communication with a computer system/server in accordance with aspects of the present disclosure.

FIGS. 4A-4C show a representative image capture technique used in accordance with aspects of the present disclosure.

FIG. 5 shows a flowchart of an exemplary method in accordance with aspects of the present disclosure.

FIG. 6 shows a control chart used in accordance with aspects of the present disclosure.

FIGS. 7A-7D show images of different nozzles in accordance with aspects of the present disclosure.

### DETAILED DESCRIPTION

The present disclosure relates to a monitoring tool and, more particularly, to a monitoring tool and method of use. More specifically, the monitoring tool and method of use may be used to monitor a dispenser nozzle used to dispense chemicals (e.g., photoresist chemistry) in photolithography processes. For example, in embodiments, the monitoring tool may detect nozzle faults using a machine-vision algorithm based on monitoring the symmetry of a nozzle image. In this way, the images can be used to identify nozzle faults to reduce defects by quantifying an asymmetry of the nozzle image.

Advantageously, the present disclosure does not need to train a model based on classified images or maintain reference images. In addition, the methods described herein allow tighter control limits as there is no variability between a test image and a reference image or uncertainty in a classification model. This leads to more robust nozzle replacement, regardless of changes in ambient light, camera adjustments or other variables. In addition, the methods described herein identify faults before they cause dispensing errors by monitoring the nozzle, itself, compared to monitoring of the dispensed chemicals in the photolithography processes. Moreover, the methods described herein do not require manual monitoring of images of the nozzle or visual inspection of the nozzle. These advantages lead to higher wafer yields in the chip manufacturing processes which can otherwise be affected by contamination on the dispenser nozzles.

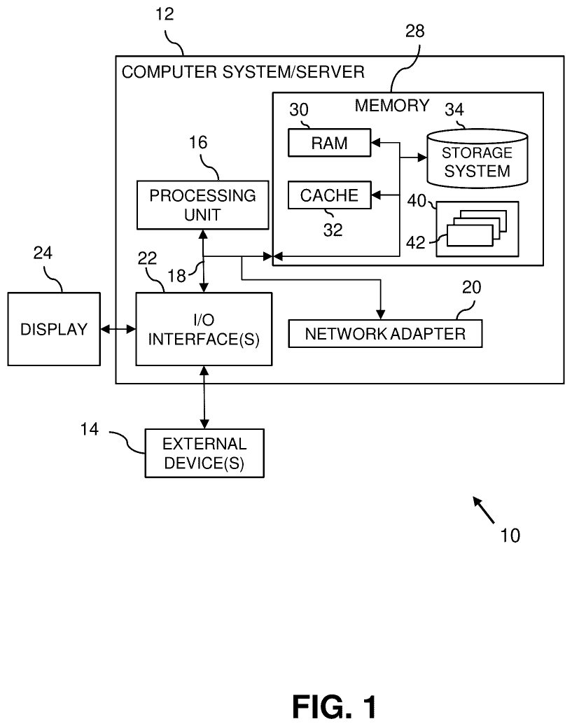

FIG. 1 depicts a computing node according to an embodiment of the present disclosure. In this regard, the present disclosure may be representative of a system, a method, and/or a computer program product at any possible technical detail level of integration. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages. The computer readable program instructions may execute entirely on the user's computer, partly on the user's computer, as a stand-alone software package, partly on the user's computer and partly on a remote computer or entirely on the remote computer or server.

As described in more detail with respect to FIG. 1, these computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

Referring now to FIG. 1, a schematic of an example of a computing node is shown. Computing node 10 is only one example of a suitable computing node and is not intended to suggest any limitation as to the scope of use or functionality of embodiments of the disclosure described herein. Regardless, computing node 10 is capable of being implemented and/or performing any of the functionality set forth hereinabove. Embodiments of the present disclosure are capable of being implemented in conjunction with any other type of computing environment now known or later developed.

In computing node 10 there is a computer system/server 12, which is operational with numerous other general purpose or special purpose computing system environments or configurations. In embodiments, the computer system/server 12 (which may be internal or external to a processing tool) may perform the functions described herein, including, for example, (i) obtaining nozzle images from a camera, (ii) analyzing the nozzle images and identifying nozzle faults using imaging default detection, and (iii) interlocking the faults by, for example, notifications, tool inhibits, and/or lot holding processes.

In more specific embodiments, the computer system/server 12 will identify the tip of the nozzle and its center point from an image taken by camera. In embodiments, the center point and edges of the nozzle can be determined by edge detection methods, e.g., image default detection to locate and center the nozzle in the image, maximize the vertical symmetry and quantify the residual asymmetry of the image. The computer system/server 12 will compare a first side of the nozzle to a second side of the nozzle to determine symmetry or asymmetry of the tip of the nozzle. This may be performed by superimposing (e.g., image mirroring) an image of the first side of the nozzle onto an image of the second side of the nozzle (or vice versa). The computer system/server 12 can identify differences between the two sides of the nozzle, e.g., if asymmetry of the nozzle exists. If the asymmetry is above a certain threshold limit, the computer system/server 12 will identify such asymmetry as contamination on the tip of the nozzle (which may affect nozzle performance and, likewise, wafer yields). In this way, the systems and methods herein do not require reference images, training of models based on classified images or manual monitoring of the nozzles.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed computing environments where tasks are performed by remote processing devices that are linked through a communications network.

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Also, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

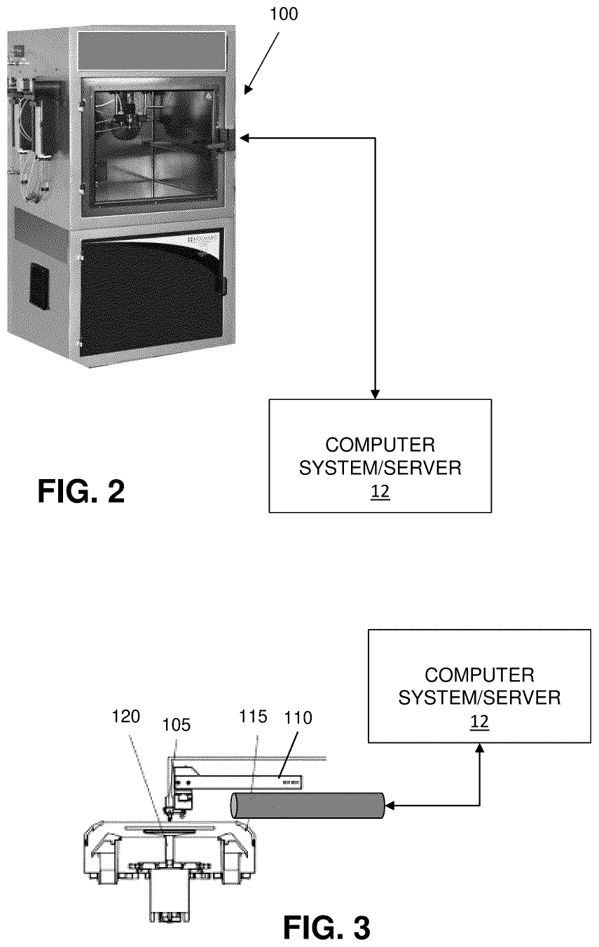

FIG. 2 shows a block diagram of an exemplary processing tool in accordance with aspects of the invention. In embodiments, the processing tool 100 is in communication with the computer system/server 12 of FIG. 1. The processing tool 100 may be a photolithography tool (also known as optical lithography). As should be understood by those of ordinary skill in the art, the photolithography tool provides processes used to create integrated circuits by transferring a pattern onto a substrate using light. The processes generally involve: (i) cleaning and preparing the substrate; (ii) applying a photosensitive material (e.g., photoresist) to the substrate using different dispensing nozzles; (iii) baking the substrate, exposing the substrate to light and baking the substrate again after exposure; (iv) developing the image; and (v) removing the photoresist to transfer the pattern to the substrate. As should be appreciated by those of skill in the art, the processing tool 100 is very complex and requires constant maintenance to ensure, for example, the nozzles do not become clogged or contaminated.

FIG. 3 shows an enlarged view of a nozzle dispensing unit of the processing tool 100. In embodiments, the nozzle dispensing unit may be in communication with the computer system/server 12 of FIG. 1. The nozzle dispensing unit includes a plurality of dispensers (e.g., nozzles) 105 mounted on a moving arm 110. In embodiments, the plurality of nozzles 105 may dispense different chemicals (, e.g., photoresist materials, etc.) on the surface of the substrate 105 based on different processing and design parameters as is known in the art such that no further explanation is required for a complete understanding of the present disclosure. The moving arm 110 may be used to position the nozzles 105 over the substrate 120 (which is held on a rotating chuck).

Still referring to FIG. 3, a camera 115 may be provided on the moving arm 110 or at other locations on the assembly. In embodiments, the camera 115 may be a digital or infrared camera designed, structured and located to image (e.g., photograph) the different nozzles 105. In embodiments, the camera 115 may be other types of cameras known in the art such that no further explanation is needed for a complete understanding of the present invention. In any embodiment of camera usage, for example, the camera 115 may image the dispensing tips of each nozzle 105. The camera 115 and/or computer system/server 12 of FIG. 1 may be configured to isolate a nozzle tip of the nozzles 105 and locate is center using edge detection techniques as described in further detail herein. The images of nozzle tips can be provided to the computer system/server 12 for further analysis as described herein.

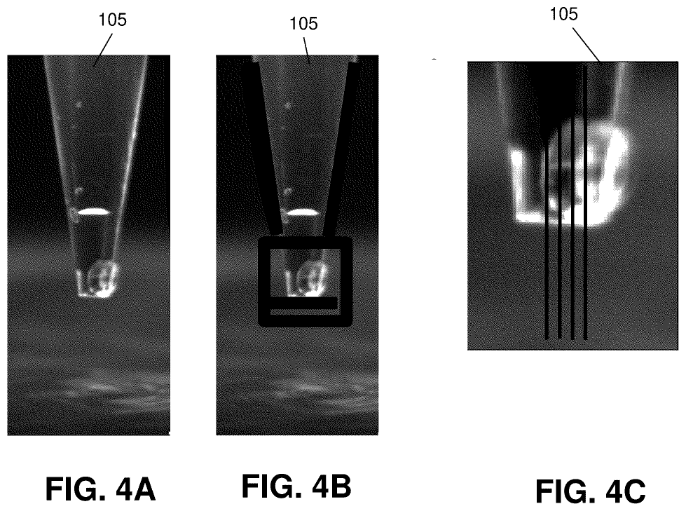

FIGS. 4A-4C show a representative image capture technique used in accordance with aspects of the present disclosure. In particular, in FIG. 4A, the camera 115 may image the nozzle tip of the nozzle 105. In FIG. 4B, an edge detection technique may be used to center and isolate the nozzle tip. In embodiments, the edge detection technique may be any known edge detection technique in the art. For example, the edge detection technique may be gradient-based methods, second-order derivative methods, optimal edge detection, multi-scale edge detection or machine learning and deep learning-based methods. For example, and more specifically, these methods (algorithms) may be Canny edge detection, Sobel edge detection, Laplacian edge detection, Gradient-based methods, Prewitt edge detection, Roberts Cross Edge Detection or holistically-nested edge detection, amongst techniques others.

As further shown in FIG. 4C, the processes may maximize symmetry using an optimal super-position of vertical reflections over a range of vertical rotations or color detection. As should be understood by those of skill in the art, in the context of edge detection, the “optimal superposition” refers to an ideal combination of filter kernels (often derived from the first derivative of a Gaussian function) that best captures edge information in an image, balancing the ability to detect sharp edges while minimizing false positives caused by noise. This achieves good localization and single response to a true edge, making it effective to determine asymmetry in the nozzle tip.

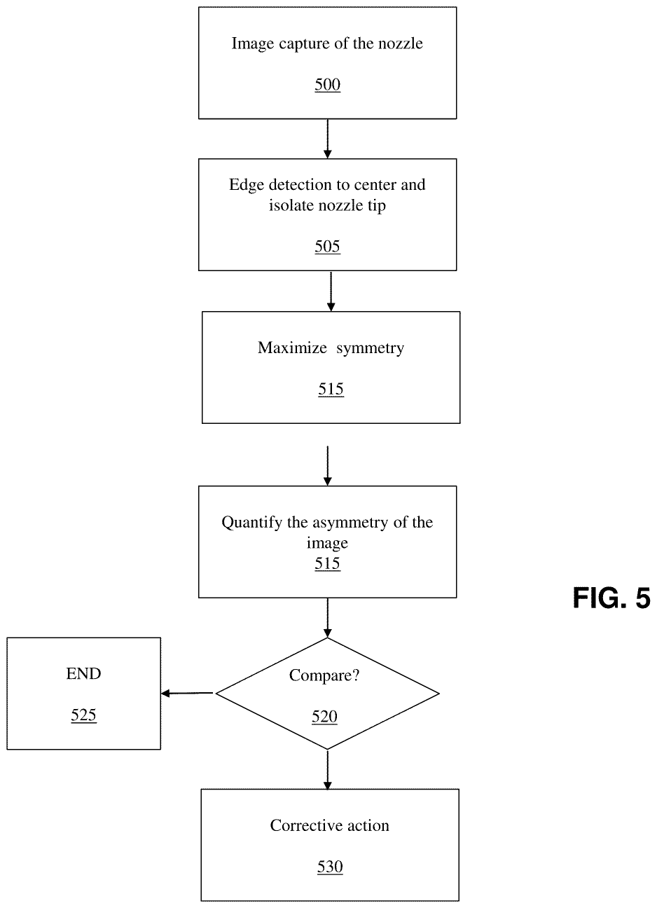

FIG. 5 shows a flowchart of an exemplary method in accordance with aspects of the present disclosure. Steps of the method may be carried out in the environment of FIGS. 1 and 2. The flowchart also illustrates the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Referring to FIG. 5, at step 500, the processes capture the image of the nozzle. For example, in embodiments, the camera can capture the image of any of the nozzles and provide such image to the computer system/server 12 of FIG. 1. At step 505, the processes perform edge detection to center and isolate the nozzle tip and its center point as described above. At step 510, the processes maximize the symmetry using, for example, an optimal super-position of vertical reflections over a range of vertical slices or through color detection. At step 515, the processes quantify the asymmetry of the image by subtracting and averaging pixel deltas of the original and optimal reflection. By way of example, in this process step, the processes may superimpose (e.g., image mirroring) the image of a first side of the nozzle onto a second side of the nozzle and compare such sides to determine if there are any differences. If a difference is identified, asymmetry of the nozzle exists, which may be indicative of contamination.

At step 520, the processes compare the residual asymmetry versus a control limit (e.g., predetermined control limit threshold). If the control limit is not exceeded, the processes will end at step 525. In other words, if the sides of the nozzle are symmetrical or within a predetermined threshold limit of asymmetry, it is determined that either no contamination exists or if some contamination exists it would not affect wafer yield. In embodiments, the control limit can be, e.g., 1%; although other thresholds are also contemplated herein.

On the other hand, should the control limit be exceeded, e.g., a determination of asymmetry of the nozzle tip representative of a contamination, the processes will continue to step 530. At step 530 a corrective action is taken. This corrective action may include, for example, providing notification to a technician that the nozzle tip is contaminated and requires maintenance. Additional corrective actions may include inhibiting further processes with the nozzle or placing a hold on the entire lot of wafers (until the contamination of the nozzle can be corrected).

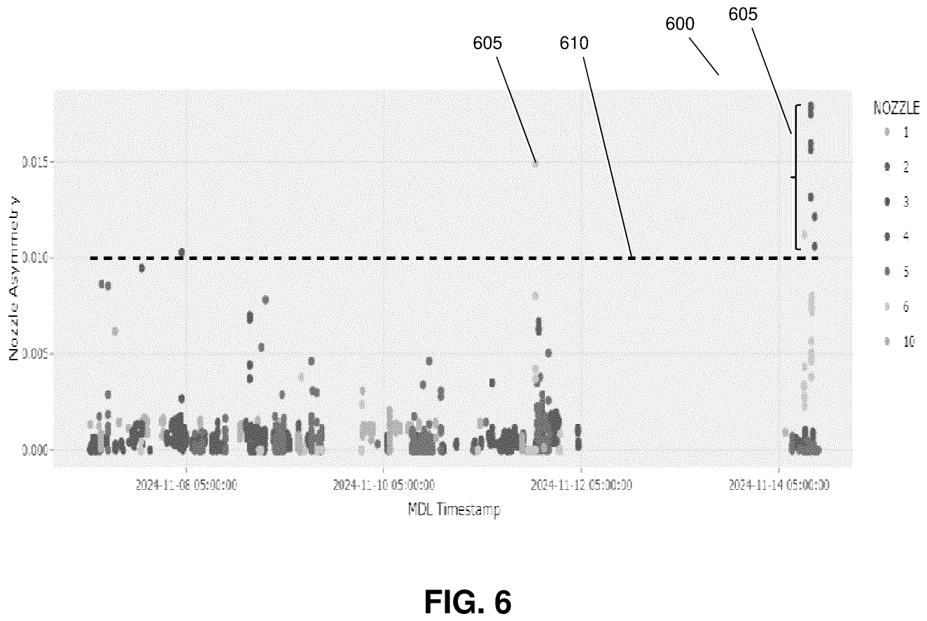

In embodiments, a statistical process control (SPC) chart 600 of FIG. 6 can be used to compare the residual asymmetry versus a control limit (e.g., 1%) to identify nozzle faults, e.g., contamination on the nozzle tip. As should be understood by those of skill in the art, the SPC chart (e.g., control chart) is a graph used to study how a process changes over time. Data are plotted in time order. As shown, the chart 600 includes data from different wafers fabricated using different nozzles, nozzles 1-6 and 10. These data are graphed along a y-axis representing nozzle asymmetry and the x-axis of time. Datapoints 605 above the central line 610 are representative of wafer defects and, hence, attributed to nozzle contamination. In this way, it is now possible to compare current data and draw conclusions about whether the process variation is consistent (in control) or is unpredictable (out of control, affected by special causes of variation, e.g., contamination on the nozzle tip).

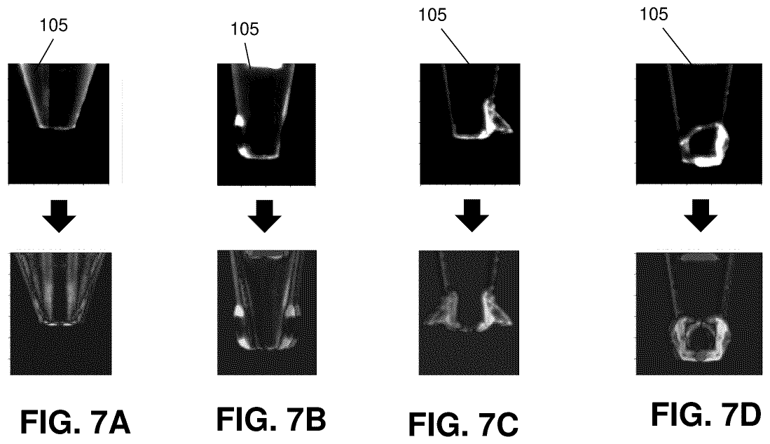

FIGS. 7A-7D show images of different nozzles 105 in accordance with aspects of the present disclosure. The top image of each of the figures shows the image of the nozzle (as taken by the camera) and the bottom image of each of the images is representative of a comparison of the sides of the nozzle tips to determine whether there is a symmetry or asymmetry of the nozzle tips.

In FIG. 7A, the images of the nozzle tips are symmetrical and no contamination exists. That is, in comparing the top image to the bottom image, there are no differences between the sides of the nozzles, even when superimposing the sides on one another.

In FIG. 7B, the top image shows an irregularity on the left side of the nozzle tip and the bottom image represents a comparison of the two sides of the nozzle tip. Although there is an asymmetry, the asymmetry does not exceed a particular control limit or threshold and, hence, the nozzle would pass inspection. In this representation, the irregularity may be identified through historical data as a bubble or drop that would not affect nozzle performance.

In both FIGS. 7C and 7D, the top image shows an irregularity on the right side of the nozzle tip and the bottom image represents a comparison of the two sides of the nozzle tip. In these cases, the asymmetry is above a particular control limit or threshold, hence being indicative of contamination. In these representations, the irregularity may be identified as dried liquid that would affect nozzle performance. Accordingly, an alert or notification would be provided.

The monitoring tool can be utilized in the fabrication of system on chip (SoC) technology. The SoC is an integrated circuit (also known as a “chip”) that integrates all components of an electronic system on a single chip or substrate. As the components are integrated on a single substrate, SoCs consume much less power and take up much less area than multi-chip designs with equivalent functionality. Because of this, SoCs are becoming the dominant force in the mobile computing (such as in Smartphones) and edge computing markets. SoC is also used in embedded systems and the Internet of Things.

The method(s) as described above is used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method, comprising:
obtaining, by a computing device, an image of a tool used in processing equipment;
comparing, by the computing device, a first side of the tool to a second side of the tool;
determining, by the computing device, whether there is an asymmetry between the first side of the tool and the second side of the tool; and
providing, by the computing device, a notification that there is the asymmetry between the first side of the tool and the second side of the tool.

2. The method of claim 1, wherein the comparing comprising a mirror imaging of the tool to ascertain any differences between the first side of the tool and the second side of the tool.

3. The method of claim 1, further comprising performing edge detection on the image to ascertain an end of the tool and a center point of the end of the tool.

4. The method of claim 3, further comprising maximizing vertical symmetry of the image and quantifying residual asymmetry of the image.

5. The method of claim 4, wherein the quantifying residual asymmetry of the image comprises subtracting and averaging pixel deltas of the image and optimal reflection.

6. The method of claim 4, wherein the maximizing of the vertical symmetry of the image comprises using an optimal super-position of vertical reflections over a range of vertical rotations.

7. The method of claim 3, wherein the tool comprises a plurality of dispensing nozzles, the edge detection locates a center of the dispensing nozzle used to quantify asymmetry of the image, and the comparing comprises mirror imaging to ascertain differences between the first side of the tool and the second side of the tool.

8. The method of claim 1, further comprising using a statistical process control (SPC) chart to ascertain faults of the tool.

9. The method of claim 1, wherein the notification comprises one of tool inhibits and lot holds.

10. The method of claim 1, further comprising determining that the asymmetry is above a control limit which is indicative of contamination on the tool and which triggers the providing of the notification.

11. A computer program product comprising one or more computer readable storage media having program instructions collectively stored on the one or more computer readable storage media, the program instructions executable to:
obtain an image of a dispensing nozzle taken by camera;
identify a tip of the dispensing nozzle and its center point by performing edge detection on the image;
compare sides of the dispensing nozzle from the image to ascertain one of symmetry and asymmetry at the tip of the dispensing nozzle;
determine that the asymmetry is above a control threshold limit; and
provide a notification of the asymmetry of the tip of the dispensing nozzle, upon determining that the asymmetry is above the control threshold limit.

12. The computer program product of claim 11, wherein the asymmetry above the control threshold limit is indicative of contamination.

13. The computer program product of claim 11, wherein the comparing the sides of the dispensing nozzle comprises superimposing a first side of the image of the dispensing nozzle onto a second side of the image of the dispensing nozzle.

14. The computer program product of claim 13, further comprising maximizing the asymmetry using a super-position of vertical slices of the image.

15. The computer program product of claim 14, wherein the edge detection locates and centers the nozzle dispenser in the image, maximizes vertical symmetry of the image and quantifies residual asymmetry of the image.

16. The computer program product of claim 11, further comprising maximizing the asymmetry using a super-position of vertical slices of the image.

17. The computer program product of claim 11, further comprising determining that the sides of the dispensing nozzle in the image are symmetrical.

18. A system comprising:
a processor, a computer readable memory, one or more computer readable storage media, and program instructions collectively stored on the one or more computer readable storage media, the program instructions executable to:
obtain an image of a dispensing nozzle;
perform edge detection to center and isolate a nozzle tip of the dispensing nozzle and maximize symmetry of the image;
quantify an asymmetry of the image by subtracting and averaging pixel deltas of the image and optimal reflection;
compare the asymmetry versus a control limit to ascertain if the asymmetry of the image is a fault; and
if the control limit is exceeded, provide a notification of contamination existing on the nozzle tip.

19. The system of claim 18, wherein the quantify the asymmetry of the image comprises subtracting and averaging pixel deltas of the image and optimal reflection.

20. The system of claim 18, wherein the asymmetry is identified by an image mirroring of different sides of the image of the dispensing nozzle.
